(19) United States
(12) Patent Application Publication
(10) Pub. No.: US 2008/0218895 A1
(43) Pub. Date: Sep. 11, 2008

(54) Systems and/or methods for controlling bias voltages between recording media and read/write heads in disk drive devices

(75) Inventors: John E. Scura, Milpitas, CA (US); Thao A. Nguyen, Milpitas, CA (US); David Tung, Livermore, CA (US)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/713,812

(22) Filed: Mar. 5, 2007

(51) Int. Cl. G11B 21/02

(52) U.S. Cl. 360/75

(57) ABSTRACT

Certain example embodiments relate to techniques for more precisely adjusting the spacing between a head and a disk in a disk drive device. A spindle motor of a disk drive device may be electrically isolated from at least the base plate by means of, for example, a nonconductive adhesive. Circuitry for monitoring and/or applying a voltage to the head and/or to the disk to control an amount of spacing between the head and the disk may be provided. In certain example embodiments, such circuitry may monitor the disk voltage and then apply an appropriate voltage bias to the head to control the spacing therebetween electrostatically. In certain other example embodiments, such circuitry may monitor the head voltage and then adjust the spindle voltage accordingly. In still other example embodiments, the disk voltage and the head voltage may be controlled and/or adjusted based on a known voltage differential so that a precise disk/head voltage potential is achieved.

### FIELD OF THE INVENTION

The example embodiments described herein relate to information recording disk drive devices and, more particularly, to techniques for controlling the bias voltage applied between recording media and read/write heads to better control the spacing therebetween.

### BACKGROUND OF THE INVENTION

One known type of information storage device is a disk drive device that uses magnetic media to store data and a movable read/write head that is positioned over the media to selectively read from or write to the disk.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

FIGS. 1a and 1b illustrate a conventional disk drive unit and show a magnetic disk 101 mounted on a spindle motor 102 for spinning the disk 101. A voice coil motor arm 104 carries a head gimbal assembly (HGA) 100 that includes a micro-actuator 105 with a slider 103 incorporating a read/write head. A voice-coil motor (VCM) is provided for controlling the motion of the motor arm 104 and, in turn, controlling the slider 103 to move from track to track across the surface of the disk 101, thereby enabling the read/write head to read data from or write data to the disk 101. In operation, a lift force is generated by the aerodynamic interaction between the slider 103, incorporating the read/write transducer, and the spinning magnetic disk 101. The lift force is opposed by equal and opposite spring forces applied by a suspension of the HGA 100 such that a predetermined flying height above the surface of the spinning disk 101 is maintained over a full radial stroke of the motor arm 104.

Thus, as will be appreciated from FIGS. 1a and 1b, hard disk drive recording heads typically are spaced away from the recording media at least partially by means of an aerodynamic bearing. This passive spacing control may be affected by various factors, including, for example, manufacturing tolerances, temperature, and barometric pressure. To achieve higher recording densities, the head/disk separation must be better controlled to reduce the affects of the tolerances and/or ambience.

Certain current technologies use a resistive heating element in addition to the aerodynamic bearing to control spacing. This heating element causes the read/write element support structure to expand when energized and to contract when switched-off. Thus, this feature theoretically can adjust for the above-mentioned spacing variations.

Unfortunately, however, this thermal adjustment technique suffers from several disadvantages. For example, such heating elements require a timing delay to achieve the desired spacing. When the resistive heater is energized, the spacing begins to change, but the programmed spacing is not achieved until the thermal difference (e.g., the un-energized versus energized temperature) of the support structure is reached. The thermal mass, thermal conductivity, ambient temperature, operating radius, and various other factors may influence this thermal rise time. Another drawback of this technique relates to power consumption. In particular, because the heat is generated by passing electric current through an electrical resistor, power is consumed. If the disk drive device is installed into a mobile device that uses a battery, the available operating time will be reduced because of an increased power draw on the battery.

Another current technique implements electrostatically assisted spacing. Instead of passing current through the resistive heater, a voltage bias is simultaneously applied to both terminals of the heater, thereby changing the voltage potential between the head and disk. This electrostatic potential may attract or repel the slider to/from the disk and change the spacing to the desired value. This electrostatic spacing change technique is advantageous because it has a good response time and because a static voltage uses very little power (e.g., a voltage potential is used to control spacing rather than a change in the current flow, thus reducing the impact on the battery life).

Unfortunately, however, this technique also suffers from several disadvantages. One potential problem is that the disk pack voltage generally is unknown and not controlled. Thus, if the spindle is assumed to be at electrical ground but is actually at some other voltage potential, the exact static voltage bias cannot be achieved. In particular, the disk pack assembly voltage level within a population of disk drives may be varied because of one or more of the following factors which may be independent of each other: the resistance of the bearing fluid of the spindle motor (e.g., a serial electrical link to ground); the resistance of the electrical adhesive that links the spindle bearing housing to ground; the inductive coupling of the spindle motor electromagnetics to the rotating disk pack; the resistance of the carbon overcoating on the disks; the internal humidity of the disk drive; and/or the amount of tribocharging generated by head/disk contact.

Thus, it will be appreciated that there is a need in the art for improved techniques for controlling head/disk separation.

### SUMMARY OF THE INVENTION

One aspect of certain example embodiments relates to techniques for more precisely adjusting the spacing between a head and a disk in a disk drive device.

Another aspect of certain example embodiments described herein relates to a spindle motor of a disk drive device being electrically isolated from at least the base plate of the disk drive device, by means of, for example, a nonconductive adhesive.

Yet another aspect of certain example embodiments described herein relates to circuitry for monitoring and/or applying a voltage to the head and/or to the disk to control an amount of spacing the head and the disk. In certain example embodiments, such circuitry may monitor the disk voltage and then apply an appropriate voltage bias to the head to control the spacing therebetween electrostatically. In certain other example embodiments, such circuitry may monitor the head voltage and then adjust the spindle voltage accordingly. In still other example embodiments, the disk voltage and the head voltage may be controlled and/or adjusted based on a known voltage differential so that a precise disk/head voltage potential is achieved.

According to certain example embodiments, a disk drive device is provided. A head gimbal assembly may include a slider including a read/write head formed thereon. A drive arm may be connected to the head gimbal assembly. A disk and a base plate may be provided. A spindle motor may be operable to spin the disk, and the spindle motor may be electrically isolated from at least the base plate. Circuitry for monitoring and/or applying a voltage to the head and/or to the disk to control an amount of spacing between the head and the disk also may be provided.

According to certain other example embodiments, a spindle motor for use in a disk drive device being operable to spin a disk of the disk drive device is provided. The spindle motor may be at least partially electrically isolated, and it may have coupled thereto circuitry for monitoring and/or applying a voltage to a head of the disk drive device and/or to the disk. The circuitry may be suitable for controlling an amount of spacing between the head and the disk.

According to still other example embodiments, a method of controlling an amount of spacing between a head and a disk in a disk drive device is provided. A spindle motor may be maintained in at least partial electrical isolation, with the spindle motor being operable to spin the disk. A voltage to the head and/or to the disk to control the amount of spacing therebetween may be monitored and/or applied.

By way of example and without limitation, a voltage may be applied to the head in dependence on a voltage applied to the disk to electrostatically control the amount of spacing based at least in part on the voltage applied to the head. Also by way of example and without limitation, a differential voltage may be to the head and/or the disk in dependence on a known voltage to control the amount of spacing between the head and the disk.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a perspective view of a conventional disk drive unit;

FIG. 1b is a partial perspective view of the conventional disk drive unit shown in FIG. 1;

FIG. 2 is a side view of a disk drive unit, in accordance with an example embodiment;

FIG. 3 is circuitry suitable for using the disk pack voltage as a reference voltage so as to apply the correct space adjusting differential voltage to the recording head, in accordance with an example embodiment;

FIG. 4 is circuitry suitable for applying a differential voltage to both the head and the disk pack so as to achieve a proper space adjusting voltage differential, in accordance with an example embodiment;

FIG. 5a is an illustrative flowchart showing an example process for using the disk pack voltage as a reference voltage so as to apply the correct space adjusting differential voltage to the recording head, in accordance with an example embodiment;

FIG. 5b is an illustrative flowchart showing an example process for applying a differential voltage to both the head and the disk pack so as to achieve a proper space adjusting voltage differential, in accordance with an example embodiment; and,

FIG. 5c is an illustrative flowchart showing an example process for using the recording head voltage as a reference voltage so as to apply the correct space adjusting differential voltage to the disk pack, in accordance with an example embodiment.

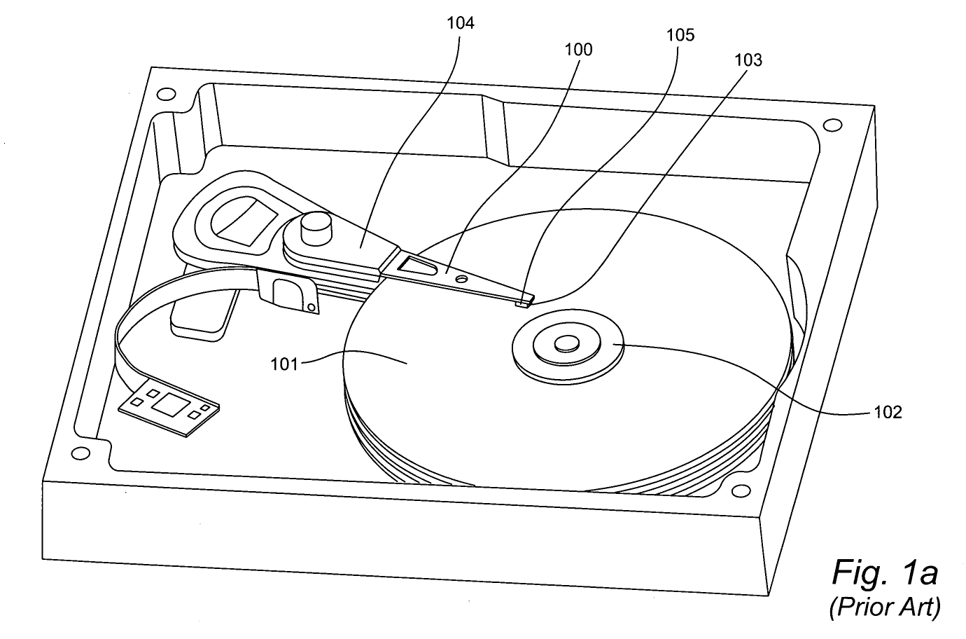

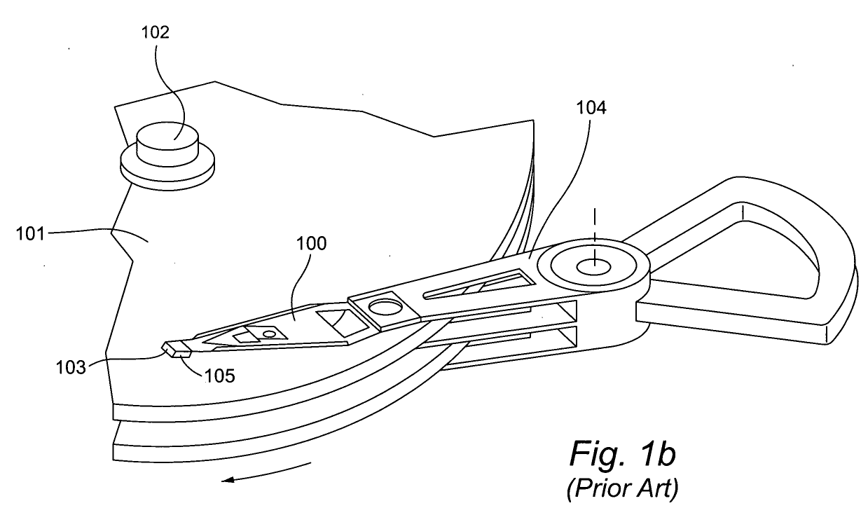

### DETAILED DESCRIPTION OF ILLUSTRATED EMBODIMENTS

Certain example embodiments provide techniques for reducing disk voltage bias uncertainty. In particular, certain example embodiments monitor the disk voltage and then apply an appropriate voltage bias to the head to control the spacing electrostatically. In certain other example embodiments, such the head voltage may be monitored and then the spindle voltage may be adjusted accordingly. Certain other example embodiments control and/or adjust the disk voltage and the head voltage based on a known voltage differential so that a precise disk/head voltage potential is achieved. Such techniques tend to result in a more precise spacing adjustment between the head and disk.

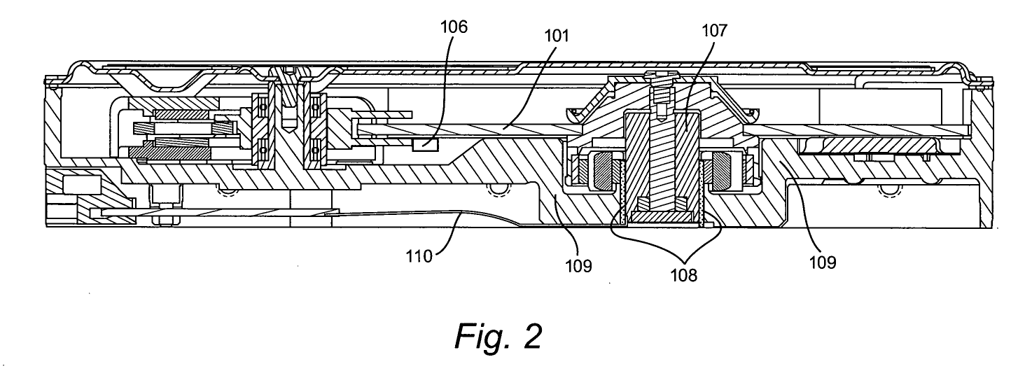

Referring now more particularly to the drawings, FIG. 2 is a side view of a disk drive unit in accordance with an example embodiment. The rotating portion of the spindle motor 102 to which the disks 101 are fastened is electrically isolated from the disk drive base plate 109 and electrical ground. The spindle motor bearing cartridge 107 is connected (e.g., bonded) to the base plate 109 with an electrically nonconductive adhesive 108. When the adhesive 108 is cured, a symmetrical adhesive gap is at least partially formed and/or maintained so that the bearing bore is substantially concentric with respect to the spindle motor bearing cartridge 107, as will be appreciated from FIG. 2. Thus, the spindle motor bearing cartridge 107 does not come into direct contact with the base plate 109 and therefore is at least partially electrically isolated.

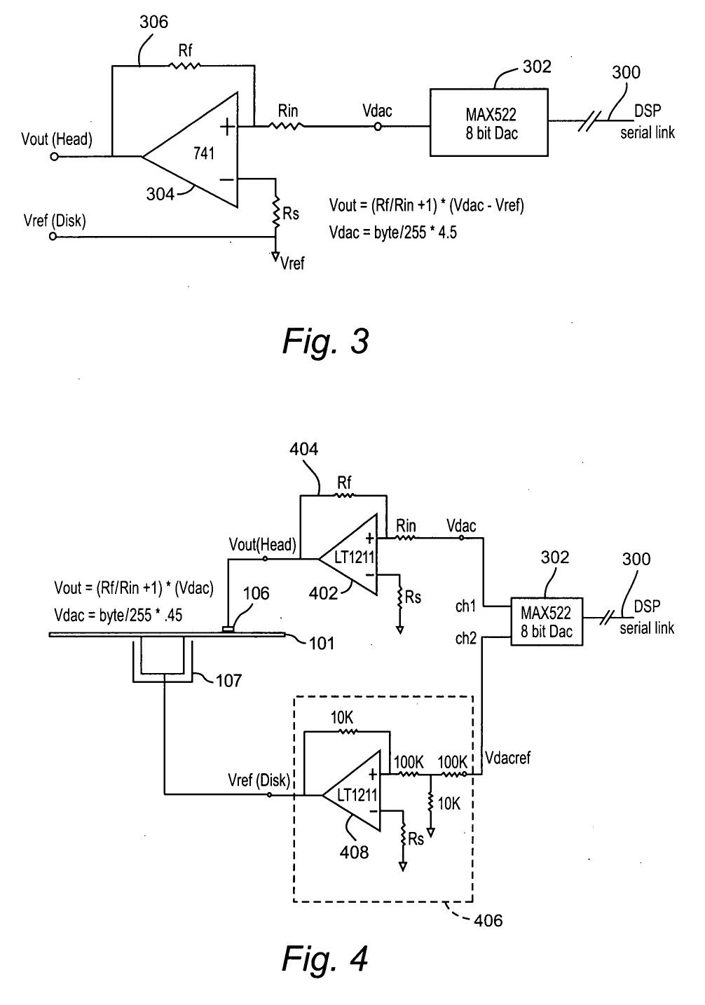

An electrical contact 110 is provided to the isolated spindle bearing cartridge, and a circuit suitable for monitoring and/or controlling the voltage applied to the spindle motor bearing cartridge 107 is provided. As will be described in greater detail below with reference to FIGS. 3 and 4 respectively, the circuit may control the spacing voltage applied to the head using the spindle bearing voltage as a reference in accordance with certain example embodiments, or by changing the voltage of the spindle bearing cartridge based on the voltage bias intended to be applied to the recording head in accordance with certain other example embodiments. As such, certain example embodiments may improve the static voltage method for controlling head-to-disk spacing by controlling and/or compensating for the voltage on the disks.

FIG. 3 is circuitry suitable for using the disk pack voltage as a reference voltage so as to apply the correct space adjusting differential voltage to the recording head, in accordance with an example embodiment. In FIG. 3, a digital signal processor (DSP) serial link 300 is provided to a digital-to-analog converter (DAC) 302. By way of example and without limitation, the DAC 302 may be capable of receiving an 8-bit “word” as a control signal from the DSP serial link 300. Of course, the present invention is not limited to 8-bit words. An input voltage Vdac is provided by the DAC 302. In certain example embodiments, the Vdac signal may be defined by the formula Vdac=byte/255*4.5, although the present invention is not so limited. Vdac is provided to a comparator 304, with resistor Rin being located between DAC 802 and comparator 304. Also fed into the comparator 304 is a reference voltage Vref, which is the disk pack voltage, passing through resistor Rs. The output voltage of the comparator 304, Vout, is connected to the same input of comparator 304 as Vdac via a feedback loop 306 which includes feedback resistor Rf. The output voltage Vout of the comparator 304 is also provided to the head. More particularly, in certain example embodiments, Vout may be defined by the following equation: Vout=(Rf/Rin+1)*(Vdac−Vref). Thus, by using the disk pack voltage as a reference voltage, the correct space adjusting differential voltage may be applied to the recording head.

FIG. 4 is circuitry suitable for applying a differential voltage to both the head and the disk pack so as to achieve a proper space adjusting voltage differential. In FIG. 4, an illustrative hydrodynamic fluid bearing electrical model 400 is shown for reference. Like FIG. 3, in FIG. 4, a digital signal processor (DSP) serial link 300 is provided to a digital-to-analog converter (DAC) 302. Again, by way of example and without limitation, the DAC 302 may be capable of receiving an 8-bit “word” as a control signal from the DSP serial link 300. Of course, the present invention is not limited to 8-bit words.

Following channel 1 (the upper portion of FIG. 4), an input voltage Vdac is provided by the DAC 302, with Vdac passing through resistor Rin before being fed into a first comparator 402. Also fed into the first comparator 402 is a static resistance that passes through resistor Rs. In certain example embodiments, the Vdac signal may be defined by the formula Vdac=byte/255*4.5, although the present invention is not so limited. The output voltage of the first comparator 402 is connected to the same input of comparator 402 as Rin after passing through resistor Rf via a feedback loop 404. The output voltage of the first comparator 402 is also provided to the head 106 (which is capable of flying over disk 101) as Vout. More particularly, in certain example embodiments, Vout may be defined by the following equation: Vout=(Rf/Rin+1)*(Vdac).

Following channel 2 (the lower portion of FIG. 4), Vdacref (a signal corresponding to Vdac on channel 1) is provided to the comparison circuitry 406. Based on the operation of the comparison circuitry 406 (which includes a second comparator 408 and various resistors), the voltage of the disk, or Vref, is changed. Accordingly, the voltage supplied to the spindle motor bearing cartridge 107 is changed. In this way, a known voltage differential is used to correctly control the voltage supplied to the head and the voltage supplied to the disk. This technique controls the voltages independently, but in accordance with a common control signal.

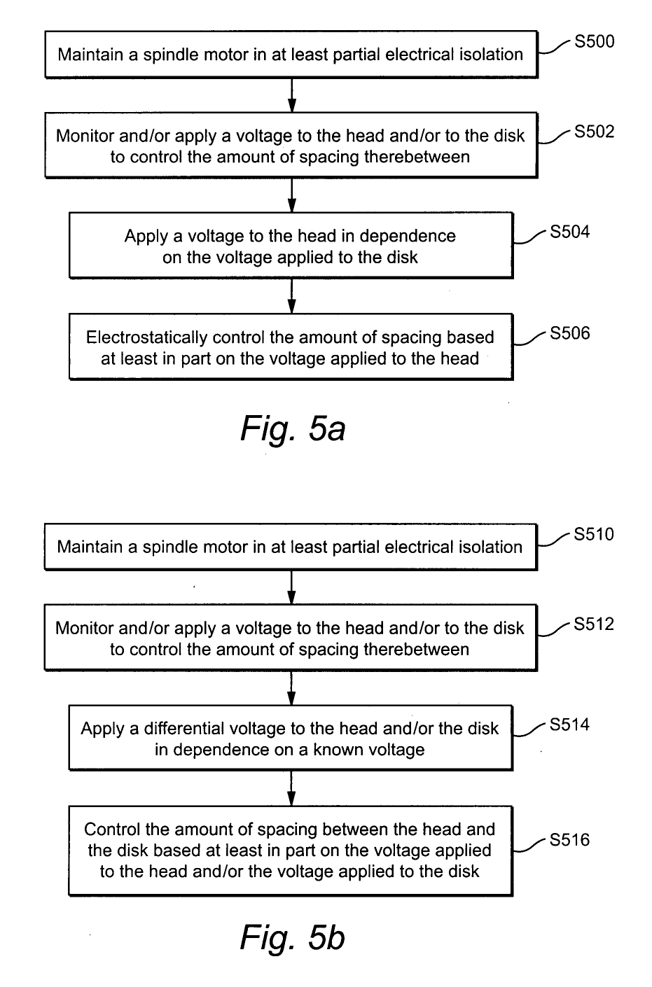

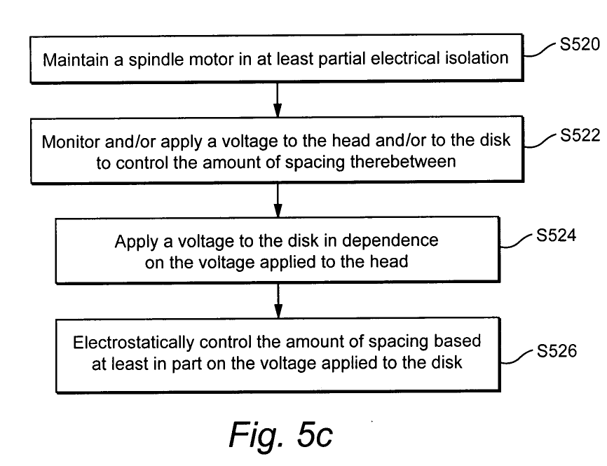

FIG. 5a is an illustrative flowchart showing an example process for using the disk pack voltage as a reference voltage so as to apply the correct space adjusting differential voltage to the recording head, in accordance with an example embodiment. In step S500, a spindle motor is maintained in at least partial electrical isolation (e.g., electrical isolation from a base plate of a disk drive device in which the spindle motor is located) using, for example, a nonconductive adhesive. Step S502 monitors and/or applies a voltage to the head and/or to the disk to control the amount of spacing therebetween. A voltage is applied to the head in dependence on the voltage applied to the disk in step S504. As a result, in step S506, the amount of spacing is electrostatically controlled based at least in part on the voltage applied to the head.

FIG. 5b is an illustrative flowchart showing an example process for applying a differential voltage to both the head and the disk pack so as to achieve a proper space adjusting voltage differential, in accordance with an example embodiment. Similar to the process described with reference to FIG. 5a, in step S510 of FIG. 5b, a spindle motor is maintained in at least partial electrical isolation. Step S512 monitors and/or applies a voltage to the head and/or to the disk to control the amount of spacing therebetween. In step S514, a differential voltage is applied to the head and/or the disk in dependence on a known voltage. The known voltage may be, for example, the voltage intended to be supplied to the recording head. As a result, in step S516, the amount of spacing between the head and the disk is controlled based at least in part on the voltage applied to the head and/or the voltage applied to the disk.

It will be appreciated that the same or similar techniques described above may be used in certain example embodiments to monitor the head voltage and then adjust the spindle voltage. More particularly, it will be appreciated that the example embodiments described above with reference to FIGS. 3 and 5a may be modified (e.g., the circuitry shown in FIG. 3 may use a different reference voltage and have a different output voltage, thus possibly requiring establishing different resistances and/or adjustment to the Vout computation) to accomplish this technique. When implemented, this technique may differ from those described above in terms of the voltage rise time involved. Nevertheless, this technique may be implemented to control the spacing between heads and magnetic disks.

For example, FIG. 5c is an illustrative flowchart showing an example process for using the recording head voltage as a reference voltage so as to apply the correct space adjusting differential voltage to the disk pack, in accordance with an example embodiment. In step S520, a spindle motor is maintained in at least partial electrical isolation (e.g., electrical isolation from a base plate of a disk drive device in which the spindle motor is located) using, for example, a nonconductive adhesive. Step S522 monitors and/or applies a voltage to the head and/or to the disk to control the amount of spacing therebetween. A voltage is applied to the disk in dependence on the voltage applied to the head in step S524. As a result, in step S526, the amount of spacing is electrostatically controlled based at least in part on the voltage applied to the disk.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A disk drive device, comprising:
a head gimbal assembly including a slider including a read/write head formed thereon;
a drive arm connected to the head gimbal assembly;
a disk;
a base plate;
a spindle motor operable to spin the disk, the spindle motor being electrically isolated from at least the base plate; and,
circuitry for monitoring and/or applying a voltage to the head and/or to the disk to control an amount of spacing between the head and the disk.

2. The disk drive device of claim 1, further comprising at least one nonconductive adhesive suitable for electrically isolating the spindle motor from at least the base plate.

3. The disk drive device of claim 2, wherein the adhesive at least partially defines an adhesive gap such that a spindle motor bearing cartridge in which the spindle motor is located and a bearing bore are substantially concentric.

4. The disk drive device of claim 1, wherein the circuitry is operable to apply a voltage to the head in dependence on the voltage applied to the disk.

5. The disk drive device of claim 4, wherein the voltage applied to the head is suitable for causing the amount of spacing between the head and the disk to be electrostatically controlled.

6. The disk drive device of claim 1, wherein the circuitry is operable to apply a differential voltage to the head and/or the disk in dependence on a known voltage.

7. The disk drive device of claim 6, wherein the known voltage corresponds to a voltage intended to be supplied to the recording head.

8. The disk drive device of claim 6, wherein the amount of spacing between the head and the disk is adjustable based at least in part on the voltage applied to the head and/or the voltage applied to the disk.

9. A spindle motor for use in a disk drive device being operable to spin a disk of the disk drive device, the spindle motor being at least partially electrically isolated and having coupled thereto circuitry for monitoring and/or applying a voltage to a head of the disk drive device and/or to the disk, the circuitry being suitable for controlling an amount of spacing between the head and the disk.

10. The spindle motor of claim 9, further comprising at least one nonconductive adhesive, the at least one adhesive being suitable for electrically isolating the spindle motor.

11. The spindle motor of claim 10, wherein the adhesive at least partially defines an adhesive gap such that a spindle motor bearing cartridge in which the spindle motor is located and a bearing bore are substantially concentric.

12. The spindle motor of claim 9, wherein the circuitry is operable to apply a voltage to the head in dependence on a voltage applied to the disk.

13. The spindle motor of claim 12, wherein the voltage applied to the head is suitable for causing the amount of spacing between the head and the disk to be electrostatically controlled.

14. The spindle motor of claim 9, wherein the circuitry is operable to apply a differential voltage to the head and/or the disk in dependence on a known voltage.

15. The spindle motor of claim 14, wherein the known voltage corresponds to a voltage intended to be supplied to the recording head.

16. The spindle motor of claim 14, wherein the amount of spacing between the head and the disk is adjustable based at least in part on the voltage applied to the head and/or the voltage applied to the disk.

17. A method of controlling an amount of spacing between a head and a disk in a disk drive device, the method comprising:
maintaining a spindle motor in at least partial electrical isolation, the spindle motor being operable to spin the disk;
monitoring and/or applying a voltage to the head and/or to the disk to control the amount of spacing therebetween.

18. The method of claim 17, wherein the spindle motor is held in electrical isolation from a base plate of the disk drive device by a nonconductive adhesive.

19. The method of claim 17, further comprising applying a voltage to the head in dependence on a voltage applied to the disk.

20. The method of claim 19, further comprising electrostatically controlling the amount of spacing based at least in part on the voltage applied to the head.

21. The method of claim 19, further comprising applying a differential voltage to the head and/or the disk in dependence on a known voltage.

22. The method of claim 21, wherein the known voltage corresponds to a voltage intended to be supplied to the recording head.

23. The method of claim 21, controlling the amount of spacing between the head and the disk based at least in part on the voltage applied to the head and/or the voltage applied to the disk.
